(19) United States
(12) Patent Application Publication
(10) Pub. No.: US 2023/0162936 A1
(43) Pub. Date: May 25, 2023

(54) RELAY DEVICE

(71) Applicants: HYUNDAI MOTOR COMPANY, SEOUL (KR); KIA CORPORATION, SEOUL (KR); KOREA ELECTRIC TERMINAL CO., LTD., INCHEON (KR)

(72) Inventors: Mun Jong Kim, Suwon-si (KR); Dohyeon Choi, Incheon (KR)

(21) Appl. No.: 17/840,954

(22) Filed: Jun. 15, 2022

(30) Foreign Application Priority Data
Nov. 25, 2021 (KR) 10-2021-0164791

(51) Int. Cl. H01H 51/06; H01H 50/16

(52) U.S. Cl. CPC H01H 51/065; H01H 50/16

(57) ABSTRACT

A relay device includes a fixed terminal having a pair of fixed contact points, a movable contact portion positioned adjacent to a lower side of the fixed terminal and configured to allow or block energization by being in contact with or spaced apart from the pair of fixed contact points, a fixed core disposed at a predetermined interval below the movable contact portion and configured to be magnetized when control power is applied, a movable core positioned adjacent to a lower side of the fixed core and configured to move toward the fixed core when the control power is applied, and a shaft that passes through the fixed core to connect to the movable contact portion and is coupled to the movable core to move together with the movable core. The shaft is supported by a step portion formed in the movable core to form a stroke gap between the fixed core and the movable core.

### CROSS REFERENCE TO RELATED APPLICATIONS

This application claims the benefit of priority to Korean Patent Application No. 10-2021-0164791, filed on Nov. 25, 2021 in the Korean Intellectual Property Office, the disclosure of which is incorporated herein by reference.

### TECHNICAL FIELD

The disclosure relates to a relay device, and more particularly, to a relay device capable for permitting or cutting off electricity in response to application of a control power.

### BACKGROUND

In general, a Direct Current (DC) relay is a device that uses the principle of an electromagnet to mechanically drive or transmit a current signal. A relay device is also called a magnetic switch, and is generally classified as an electrical circuit switch device.

Such a relay device includes a fixed contact point and a movable contact. The fixed contact point is connected to an external power source and a load so as to be energized. The movable contact point may be operated to contact or separate from the fixed contact point in response to the application of a control power. To move the movable contact point, the relay device is provided with a fixed core, a shaft passing through the fixed core and connected to the movable contact point, and a movable core coupled to the shaft to move toward the fixed core together with the shaft. The shaft is fixed to the movable core by welding while penetrating the movable core and slidably connected through the fixed core.

More specifically, when a control power is applied to a coil assembly disposed to surround the fixed core and the movable core, an electromagnetic field is formed to magnetize the fixed core, so that an attractive force is generated between the fixed core and the movable core. At this time, because the fixed core is provided in a fixed state, the movable core is moved toward the fixed core. In other words, the shaft moving together with the movable core allows the movable contact point to be contacted with the fixed contact point, so that the relay device may be energized with an external power source and a load.

When manufacturing such a relay device, a distance in which a movable core may be moved, that is, a stroke gap, is formed between a movable core and a fixed core, so that assembly is performed. For example, in the relay device, the stroke gap is required to turn the relay device on/off while the movable core moves. To form the stroke gap, a separate jig or a gap gauge is used. In other words, after the jig is disposed between the movable core and the fixed core or between the movable core and a plate, a shaft is fixed to the movable core by welding or the like.

However, in order to form the stroke gap, a process of fixing the movable core to the separate jig or positioning the stroke gap gauge between the fixed core and the movable core is required, which causes disadvantages of manufacturing as well as a cost increase due to an increase in the manufacturing process.

### SUMMARY

An aspect of the disclosure is to provide a relay device capable of uniformly forming a stroke gap without a separate jig or a gap gauge by forming a step for adjusting the stroke gap on a shaft.

Additional aspects of the disclosure will be set forth in part in the description which follows and, in part, will be obvious from the description, or may be learned by practice of the disclosure.

In accordance with an aspect of the disclosure, a relay device includes a fixed terminal having a pair of fixed contact points, a movable contact portion positioned adjacent to a lower side of the fixed terminal and configured to allow or block energization by being in contact with or spaced apart from the pair of fixed contact points, a fixed core disposed at a predetermined interval below the movable contact portion and configured to be magnetized when control power is applied, a movable core positioned adjacent to a lower side of the fixed core and configured to move toward the fixed core when the control power is applied, and a shaft that passes through the fixed core to connect to the movable contact portion, the shaft being is coupled to the movable core to move together with the movable core. The shaft is supported by a step portion formed in the movable core to form a stroke gap between the fixed core and the movable core.

A plunger for connecting to the movable contact portion may be coupled to an upper portion of the shaft, and a length of the shaft exposed to a lower portion of the plunger corresponds to the sum of the lengths of the fixed core, the movable core, and the stroke gap.

The shaft may include an upper shaft passing through the fixed core, and a lower shaft having a diameter smaller than the upper shaft and coupled to the movable core, and a stepped portion positioned between the upper shaft and the lower shaft.

A movable through-hole may be formed in the movable core in a longitudinal direction, and the step portion may be provided in the movable through-hole to support the stepped portion in a state in which the lower shaft and the movable core are assembled.

The movable through-hole may include an upper movable through-hole having a diameter larger than a diameter of the upper shaft, and a lower movable through-hole having a diameter smaller than the diameter of the upper shaft, and the lower shaft is inserted and fixed to the lower movable through-hole.

A fixed through-hole may be formed in the fixed core in a longitudinal direction, and the fixed through-hole may include an upper fixed through-hole through which the upper shaft passes, and a lower fixed through-hole having a larger diameter than that of the upper fixed through-hole.

The relay device may further include a return spring interposed in the lower movable through-hole and the upper movable through-hole.

The relay device may further include a coil assembly surrounding the fixed core and the movable core and configured to form an electromagnetic field when the control power is applied, and the fixed core is configured to be magnetized by the electromagnetic field formed by the coil assembly.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 is a perspective view illustrating a relay device according to an embodiment of the disclosure;

FIG. 2 is a cross-sectional view taken along line II-II′ of FIG. 1;

FIG. 3 is a bottom perspective view illustrating a coupling state between a fixed core and a movable core provided in a relay device according to an embodiment of the disclosure;

FIG. 4 is a cross-sectional view illustrating a state in which a fixed core and a movable core provided in the relay device are coupled to the shaft according to an embodiment of the disclosure; and

FIG. 5 is a cross-sectional view illustrating an operation state of a relay device according to an embodiment of the disclosure.

### DETAILED DESCRIPTION

Hereinafter, the embodiments of the disclosure will be described in detail with reference to accompanying drawings. It should be understood that the terms used in the specification and the appended claims should not be construed as limited to general and dictionary meanings, but interpreted based on the meanings and concepts corresponding to technical aspects of the disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

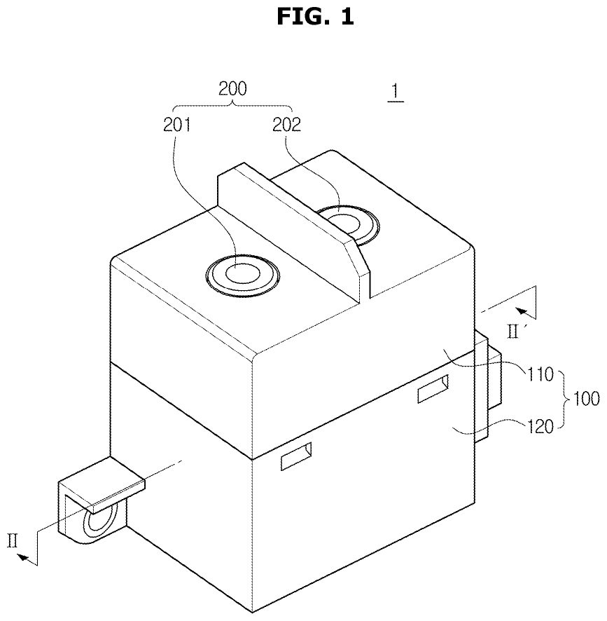

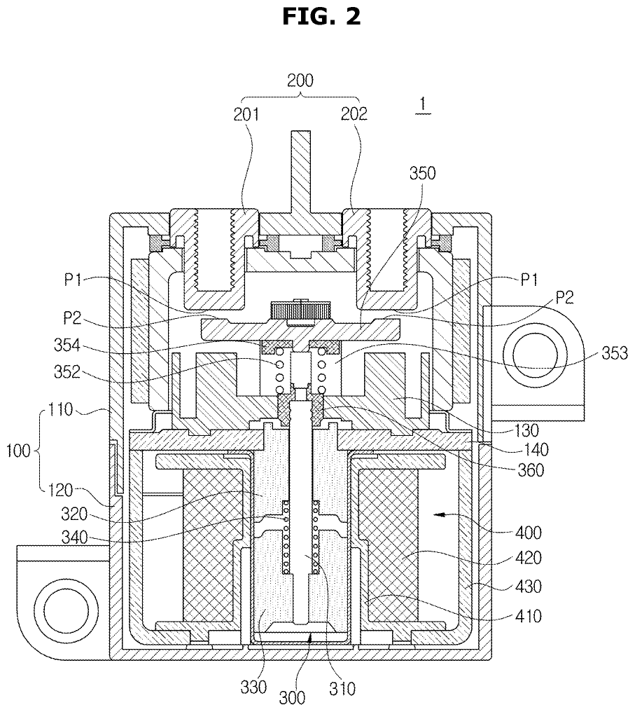

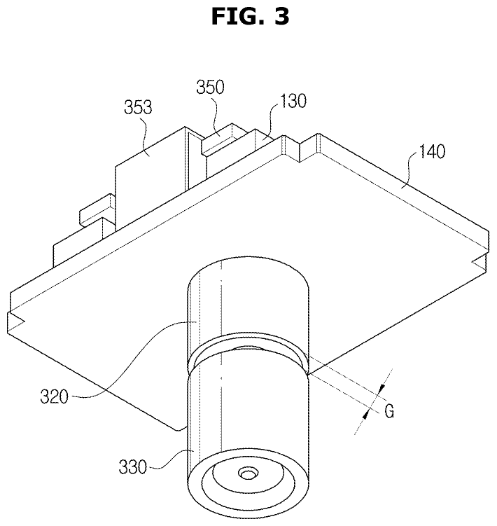

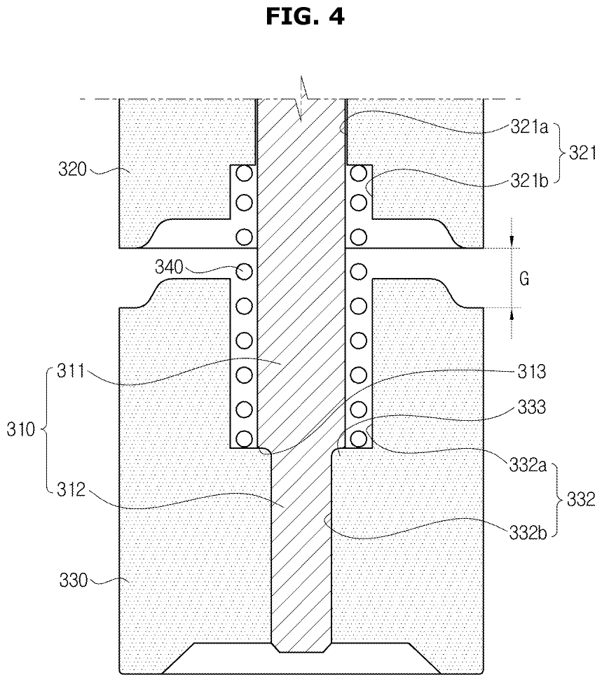

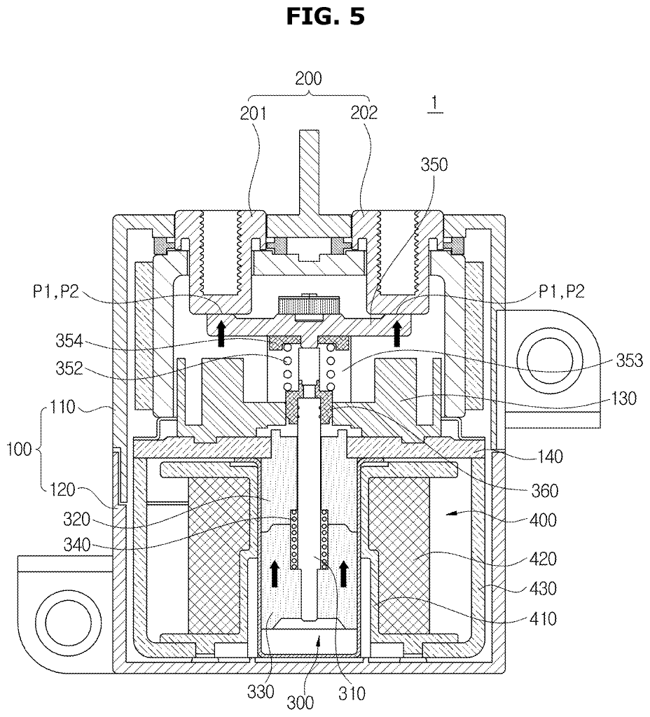

FIG. 1 is a perspective view illustrating a relay device according to an embodiment of the disclosure, FIG. 2 is a cross-sectional view taken along line II-II′ of FIG. 1, FIG. 3 is a bottom perspective view illustrating a coupling state between a fixed core and a movable core provided in a relay device according to an embodiment of the disclosure, FIG. 4 is a cross-sectional view illustrating a state in which a fixed core and a movable core provided in the relay device are coupled to the shaft according to an embodiment of the disclosure, and FIG. 5 is a cross-sectional view illustrating an operation state of a relay device according to an embodiment of the disclosure.

Referring to FIGS. 1 to 5, a relay device 1 according to an embodiment of the disclosure may include a housing 100, a fixed terminal 200, a movable unit 300, and a coil assembly 400.

The housing 100 has an internal space to safely accommodate main components, and forms the exterior of the relay device 1. For example, the housing 100 may be provided in a substantially rectangular box shape, but the shape thereof may be freely deformed according to the place to be installed or other conditions. The housing 100 may be formed of an insulating material such as a synthetic resin to prevent the inside and outside of the housing 100 from being arbitrarily energized.

Furthermore, the housing 100 is divided into an upper housing 110 and a lower housing 120, and may include an insulating plate 130 and a support plate 140.

The upper housing 110 and the lower housing 120 are formed such that the surfaces facing each other are open, and the open facing surfaces are coupled to each other to form an inner space therebetween. The insulating plate 130 and the support plate 140 are installed in the inner space.

The insulating plate 130 and the support plate 140 are installed in a vicinity of the center of the housing 100, and electrically and physically separate upper and lower spaces based on the insulating plate 130 and the support plate 140. In other words, any energization between the fixed terminal 200 provided in the upper space, and a movable contact portion 350 to be described later and cores 320 and 330 provided in the lower space may be prevented.

The insulating plate 130 may be formed of an insulating material such as a synthetic resin to electrically separate the upper housing 110 and the lower housing 120 from each other.

The support plate 140 may be provided to physically separate the upper housing 110 and the lower housing 120. As shown in drawings, the support plate 140 may be provided to support the insulating plate 130. The support plate 140 may be formed of a magnetic material. Accordingly, the support plate 140 may form a magnetic circuit together with the fixed core 320 and a yoke 430 when a control power is applied to the coil assembly 400 to be described later. In other words, a driving force for moving the movable core 330 toward the fixed core 320 may be formed by a magnetic path.

A through-hole is formed in a center of the insulating plate 130 and the support plate 140. A plunger 360 coupled to a shaft 310 to be described later is movably coupled to the through-hole in a vertical direction. Therefore, when the movable core 330 moves in the direction toward or away from the fixed core 320, the shaft 310 and the plunger 360 move together, and thus the movable contact portion 350 connected to the plunger 360 may also be moved together in the same direction. Operation of the movable contact portion 350 according to operation of the movable core 330 and a coupling structure with the shaft 310 will be described again below.

The fixed terminal 200 may be provided as a pair and be fixedly mounted to the housing 100. For example, the fixed terminals 200 may include a first fixed terminal 201 and a second fixed terminal 202, and may be arranged side by side at a predetermined interval. As shown in drawings, the first and second fixed terminals 201 and 202 are installed on an upper side of the upper housing 110 and are physically separated from each other. However, when the movable contact portion 350, which will be described later, comes into contact with the first and second fixed terminals 201 and 202, the first and second fixed terminals 201 and 202 may be in an electrically energizable state. In other words, according to the position of the movable contact portion 350, whether electricity is energized between the first and second fixed terminals 201 and 202 may be determined. Accordingly, a pair of fixed contact points P1 are provided at a lower side of the fixed terminals 200, and the corresponding movable contact portion 350 is provided with movable contact points P2 in contact with the fixed contact points P1.

The movable unit 300 is provided to serve to move the movable contact portion 350 so that the movable contact points P2 and the fixed contact points P1 come into contact with each other. In this case, the movable unit 300 may be operated by an electromagnetic field generated through the coil assembly 400.

More specifically, the movable unit 300 may include the shaft 310, the fixed core 320, the movable core 330, the plunger 360, a return spring 340, and the movable contact portions 350. The shaft 310 may be coupled passing through the fixed core 320 and the movable core 330. The fixed core 320, the movable core 330, and the return spring 340 are arranged in a lower space of the housing 100, and the plunger 360 and the movable contact portion 350 may be disposed in an upper space of the housing 100.

The shaft 310 has a predetermined length, and is divided into an upper shaft 311 passing through the fixed core 320 in a longitudinal direction and a lower shaft 312 having a diameter smaller than that of the upper shaft 311 and coupled to the movable core 330. Accordingly, a stepped portion 313 may be provided between the upper shaft 311 and the lower shaft 312. At this time, the upper shaft 311 may pass through the fixed core 320 and be movably coupled from the fixed core 320, and the upper end thereof protrudes from the upper portion of the fixed core 320 to be coupled with the plunger 360. Furthermore, because the lower shaft 312 is coupled to the movable core 330, the shaft 310 is provided to move together with the movable core 330 when the movable core 330 is operated.

The fixed core 320 is installed on the support plate 140 to restrict a movement thereof, and is magnetized by a magnetic field generated by the coil assembly 400 to generate electromagnetic attraction. Accordingly, the movable core 330 is moved toward the fixed core 320 by the electromagnetic attraction. The fixed core 320 may be provided in any shape capable of generating electromagnetic force by being magnetized by a magnetic field. For example, the fixed core 320 may be provided with a permanent magnet or an electromagnet.

Furthermore, a fixed through-hole 321 is formed in a center of the fixed core 320. The shaft 310 may be vertically movable through the fixed through-hole 321. In other words, the shaft 310 may be connected to the movable contactor 350 through the fixed through-hole 321. The fixed through-hole 321 may include an upper fixed through-hole 321a through which the upper shaft 311 of the shaft 310 passes, and a lower fixed through-hole 321b having a diameter larger than that of the upper shaft 311. An upper portion of a return spring 340, which will be described later, is inserted into the lower fixed through-hole 321b so that the upper end thereof may be supported.

The movable core 330 may be positioned to be spaced apart from the fixed core 320 by a predetermined distance. Therefore, a distance at which the movable core 330 and the fixed core 320 are spaced apart and the movable core 330 may move toward the fixed core 320 may be defined as a stroke gap G. In other words, as the movable core 320 moves by the stroke gap G, the on/off of the relay device 1 is controlled.

A movable through-hole 332 is formed in the movable core 330 in a longitudinal direction. The movable through-hole 332 may include an upper movable through-hole 332a having a diameter larger than that of the upper shaft 311 and a lower movable through-hole 332b having a diameter smaller than that of the upper shaft 311. Accordingly, a step portion 333 is formed between the upper movable through-hole 332a and the lower movable through-hole 332b. As a result, in a state in which the lower shaft 312 and the movable core 330 are assembled, the stepped portion 313 may be provided to be supported by the step portion 333.

A lower portion of the return spring 340, which will be described later, is inserted into the upper movable through-hole 332a so that the lower end thereof may be supported.

The lower movable through-hole 332b may have a diameter corresponding to that of the lower shaft 312, and the lower shaft 312 may be inserted into the lower movable through-hole 332b to be fixed by welding or the like.

As described above, an upper portion of the shaft 310 is provided to penetrate the fixed core 320 so as to be coupled with the plunger 360 to be connected to the movable contact portion 350. Accordingly, the length of the shaft 310 exposed to the lower portion of the plunger 360 may be provided to have a length corresponding to the sum of the lengths of the fixed core 320, the movable core 330, and the stroke gap G. In other words, because the stepped portion 313 of the lower shaft 312 is coupled in a supported state to the step portion 333 of the movable core 330, the stroke gap G may be easily formed without using a separate jig or gap gauge.

When power is applied to the coil assembly 400 in a state in which the shaft 310 is coupled to the fixed core 320 and the movable core 330, the fixed core 320 is magnetized such that the movable core 330 is moved upward by the stroke gap G, and the return spring 340 is compressed and the elastic restoring force is stored. Accordingly, when the application of the control power is released and then the magnetization of the fixed core 320 is terminated, the movable core 330 may be returned by moving downward by the stroke gap G again by the elastic restoring force.

The movable contact portion 350 is disposed in the upper space of the housing 100, and is provided to be spaced apart from the fixed terminals 200 by a predetermined interval. The movable contact points P2 of the movable contact portion 350 is provided to face the fixed contact points P1 of the fixed terminals 200.

The lower side of the movable contact portion 350 is elastically supported by a compression spring 352 so that the movable contact portion 350 moves in association with operation of the movable core 330. At this time, the compression spring 352 may elastically support the movable contact portion 350 in a compressed state by a predetermined distance so that the movable contact portion 350 does not move arbitrarily downward. Here, the compression spring 352 may be provided in a compressed state by a predetermined distance by a cover 353 coupled between the plunger 360 and the movable contact portion 350.

As shown in drawings, an upper end of the compression spring 352 may be elastically supported by the movable contact portion 350, and a lower end thereof may be elastically supported by an upper end of the plunger 360. Furthermore, a retainer 354 may be installed at a lower end of the movable contact portion 350 so that the compression spring 352 is stably maintained, and the upper end of the compression spring 352 may be installed in the retainer 354.

As such, when the shaft 310 moves upward in response to the operation of the movable core 330 in a state in which the movable contact portion 350 and the shaft 310 are connected, the plunger 360 coupled to the upper end of the shaft 310 and the movable contact portion 350 connected to the plunger 360 move together, so that the fixed contact points P1 and the movable contact points P2 come into contact with each other. At this time, when the fixed contact points P1 and the movable contact points P2 are in contact, the movable contact portion 350 tends to be spaced apart from the fixed terminals 200 by electromagnetic repulsive force. However, because the compression spring 352 is compressed by a predetermined distance to elastically support the movable contact portion 350 in a state in which the elastic restoring force is stored, even if the electromagnetic repulsive force is generated between the movable contact portion 350 and the fixed terminals 200, the movable contact portion 350 is not moved arbitrarily, thereby maintaining a stable contact state.

The coil assembly 400 is provided in a cylindrical shape with a hollow central passage and is disposed to surround the fixed core 320 and the movable core 330. The coil assembly 400 may be configured to form an electromagnetic field when the control power is applied. In other words, the fixed core 320 and the movable core 330 may be arranged along the hollow central passage of the coil assembly 400.

The coil assembly 400 includes a bobbin 410, a coil 420, and a yoke 430. The coil 420 is wound around the bobbin 410, and the bobbin 410 is accommodated in the yoke 430.

The yoke 430 is accommodated in the lower housing 120. In other words, the yoke 430, the coil 420, and the bobbin 410 on which the coil 420 is wound are sequentially arranged in a direction from an outer circumference of the lower housing 120 to the inside thereof. The yoke 430 forms a magnetic path when the control power is applied. Accordingly, the yoke 430 may be formed of a conductive material capable of conducting electricity. The magnetic path formed by the yoke 430 may be configured to control a direction of the electromagnetic field formed by the coil 420. Accordingly, when the control power is applied to the coil 420, the coil 420 forms the electromagnetic field in a direction in which the movable core 330 moves toward the fixed core 320. Furthermore, the fixed core 320 is magnetized by the electromagnetic field, so that the attractive force may be applied to the movable core 330.

The coil assembly 400 is a well-known technology, and a detailed description thereof will be omitted.

As described above, in the relay device 1 according to an embodiment of the disclosure, when the shaft 310 is coupled between the movable core 330 and the fixed core 320, the stepped portions 313 of the shaft 310 is coupled to be supported by the step portion 333 of the movable core 330, so that the stroke gap G of the movable core 330 may be easily secured, leading to improving assembly.

As is apparent from the above, the embodiment of the disclosure may provide the relay device capable of providing ease of manufacture by forming the stroke gap without a separate jig or a gap gauge in order to form the stroke gap of the movable core, as well as reducing manufacturing cost by shortening the manufacturing process.

As described above, although a few embodiments of the disclosure have been shown and described, it would be appreciated by those skilled in the art that changes may be made in these embodiments without departing from the principles and spirit of the disclosure, the scope of which is defined in the claims and their equivalents.

1. A relay device, including:
a fixed terminal having a pair of fixed contact points;
a movable contact portion positioned adjacent to a lower side of the fixed terminal and configured to allow or block energization by being in contact with or spaced apart from the pair of fixed contact points;
a fixed core disposed at a predetermined interval below the movable contact portion and configured to be magnetized when a control power is applied;
a movable core positioned adjacent to a lower side of the fixed core and configured to move toward the fixed core when the control power is applied; and
a shaft that passes through the fixed core to connect to the movable contact portion, the shaft being coupled to the movable core to move together with the movable core;
wherein the shaft is supported by a step portion formed in the movable core to form a stroke gap between the fixed core and the movable core.

2. The relay device of claim 1, wherein a plunger for connecting to the movable contact portion is coupled to an upper portion of the shaft, and a length of the shaft exposed to a lower portion of the plunger corresponds to the sum of the lengths of the fixed core, the movable core, and the stroke gap.

3. The relay device of claim 1, wherein the shaft includes an upper shaft passing through the fixed core, and a lower shaft having a diameter smaller than the upper shaft, and coupled to the movable core, and a stepped portion positioned between the upper shaft and the lower shaft.

4. The relay device of claim 3, wherein a movable through-hole is formed in the movable core in a longitudinal direction, and the step portion is provided in the movable through-hole to support the stepped portion in a state in which the lower shaft and the movable core are assembled.

5. The relay device of claim 4, wherein the movable through-hole includes an upper movable through-hole having a diameter larger than a diameter of the upper shaft, and a lower movable through-hole having a diameter smaller than the diameter of the upper shaft, and the lower shaft is inserted and fixed to the lower movable through-hole.

6. The relay device of claim 5, wherein a fixed through-hole is formed in the fixed core in a longitudinal direction, and the fixed through-hole includes an upper fixed through-hole through which the upper shaft passes, and a lower fixed through-hole having a larger diameter than that of the upper fixed through-hole.

7. The relay device of claim 6, further including a return spring interposed in the lower movable through-hole and the upper movable through-hole.

8. The relay device of claim 1, further including:
a coil assembly surrounding the fixed core and the movable core, and configured to form an electromagnetic field when the control power is applied;
wherein the fixed core is configured to be magnetized by the electromagnetic field formed by the coil assembly.
